(19) United States
(12) Patent Application Publication
(10) Pub. No.: US 2008/0320401 A1
(43) Pub. Date: Dec. 25, 2008

(54) TEMPLATE-BASED DEPLOYMENT OF USER INTERFACE OBJECTS

(76) Inventors: Padmashree B, Bangalore (IN); Markus Cherdron, Muhlhausen (DE); Ivan Perelomov, Walldorf (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/766,529

(22) Filed: Jun. 21, 2007

(51) Int. Cl. G06F 3/048

(52) U.S. Cl. 715/762

(57) ABSTRACT

A system may include reception of a model describing a plurality of user interface elements, modification of a markup language template based on the model, and deployment of the modified template to a runtime environment. Further aspects may include reception of a second model describing a second plurality of user interface elements, transformation of the second model to a metadata model in accordance with a common metadata framework, transformation of the metadata model to a generic runtime model, and transformation of the generic runtime model to a runtime model associated with a runtime environment.

### FIELD

Some embodiments relate to the development and deployment of graphical user interfaces for applications. In particular, some embodiments concern template-based deployment of graphical user interface objects.

### BACKGROUND

U.S. Patent Application Publication No. 2007/0094609 describes systems for creating platform-independent declarative and executable representations of graphical user interfaces (GUIs) for applications. As described therein, an application developer may model a GUI within a design-time environment. Examples of such an environment include, but are not limited to, Visual Composer® and Developer Studio® software applications from SAP AG. The design-time environment creates a model of the GUI which conforms to a design-time modeling language. The above-mentioned software applications may support, for instance, the Generic Modeling Language (GML) for such purposes.

The design-time environment converts the design-time model to a specification conforming to a platform-independent declarative language such as executable GUI Language (XGL). Next, framework-specific code generators or interpreters are used to execute the XGL specification. For example, code generators may generate Java code or Flash code based on the XGL specification. Alternatively, an XGL interpreter may be used in conjunction with a corresponding runtime engine (e.g., DHTML, Web Dynpro) to execute the XGL specification.

The foregoing system may provide efficient development of platform-independent application GUIs. For any one particular platform, however, other techniques may provide more-efficient GUI development. Conventional systems sacrifice the ability to exploit these more-efficient techniques in exchange for the flexibility provided by a platform-independent architecture.

Systems are desired to facilitate the development cycle of application GUIs within an infrastructure providing platform-independent GUI development.

### BRIEF DESCRIPTION OF THE DRAWINGS

FIG. 1 is a block diagram of a system architecture according to some embodiments.

FIG. 2 is a flow diagram of a process according to some embodiments.

FIG. 3 illustrates a portion of a markup language template according to some embodiments.

FIG. 4 is a block diagram of a runtime environment according to some embodiments.

### DETAILED DESCRIPTION

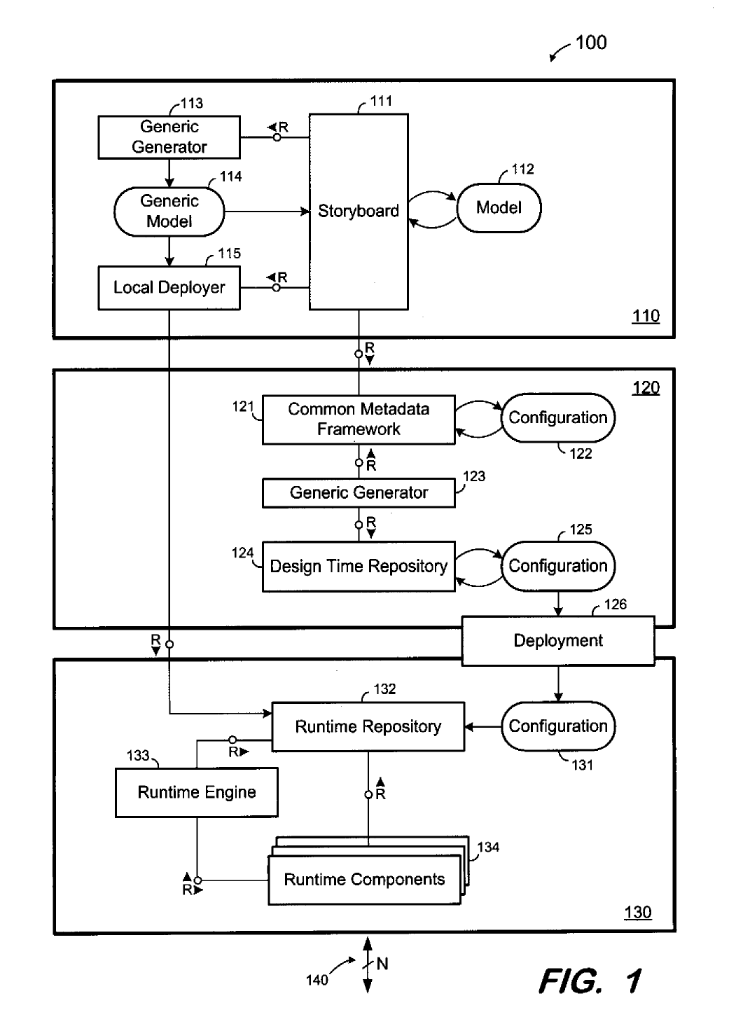

FIG. 1 is a block diagram of an architecture of system 100 according to some embodiments. System 100 includes development client 110, development server 120 and runtime environment 130. In some embodiments, system 100 is implemented by the NetWeaver® suite offered by SAP AG. System 100 may be used to develop GUIs and provide such GUIs via client browser connections 140. System 100 may implement, among other features, the features described in aforementioned U.S. Patent Application Publication No. 2007/0094609, the contents of which are incorporated herein by reference for all purposes.

The illustrated elements of system 100 may be distributed across any number of hardware devices, and are not to be deemed limited to the illustrated distribution among elements 110, 120 and 130. Moreover, the operations described below with respect to an element may be shared with or exclusively performed by another illustrated or unshown element.

Storyboard 111 of development client 110 may comprise an interface for constructing GUI models. A GUI model may include components defining UI elements and relationships between the elements. Model 112 represents a GUI model that may be created and/or edited using storyboard 111. In some embodiments, model 112 is GML model and storyboard 111 comprises an element of Visual Composer® mentioned above, but embodiments are not limited thereto.

Generic generator 103 may convert model 112 to generic model 114, comprising a generic representation of user interface elements. Generic model 114 may comprise an XGL model that is independent of any particular GUI framework or runtime platform. Generic model 114 may also be independent of a target device on which its GUI is to be displayed.

According to some embodiments, local deployer 115 receives generic model 114, modifies a markup language template based on generic model 114, and provides the modified template to runtime environment 130. Such an arrangement may provide a relatively simple and robust system to deploy a GUI model. Further details of local deployer 115 according to some embodiments will be provided below.

To contrast the above-described operation of local deployer 105, development server 120 is now considered. Development server 120 may comprise a conventional development server as provided by the NetWeaver® suite. Server 120 comprises common metadata framework 121 to receive a semantic transformation of model 112. The semantically-transformed model is stored in configuration 122, and allows disparate development clients to cooperate and interoperate with one another during development of the model. Such a semantically-transformed model typically includes information that is not needed or optimized for runtime.

Generic generator 123 may therefore semantically transform the model of framework 121 to a generic representation of user interface elements such as the above-described XGL model. The generic representation is received by design time repository and stored among configuration 125. According to some embodiments, configuration 125 stores a first generic representation that conforms to the design-time language (e.g., GML) eXtended Markup Language (XML) schema, and a second generic representation conforming to the generic language (e.g., XGL) XML schema.

In conventional systems, deployment module 126 may thereafter transform the generic representation to an executable runtime model. The particular format of the runtime model depends upon the desired runtime environment. As described above, deployment module 126 may include framework-specific code generators to generate Java code or Flash code based on the XGL model. Some runtime environments may require little or no transformation of the generic representation. For example, a runtime engine may include an XGL interpreter to directly execute a generic XGL model. Configuration 131 of runtime environment may store the runtime model in object form.

Runtime repository 132 provides runtime engine 133 with executable runtime object instances. These object instances may comprise objects of the runtime model mentioned above. Runtime repository 132 may also or alternatively provide markup language templates to runtime engine 133. Runtime engine 133 may operate in conjunction with runtime components 134 to provide graphical user interfaces to client browsers based on the runtime model objects and/or the markup language templates.

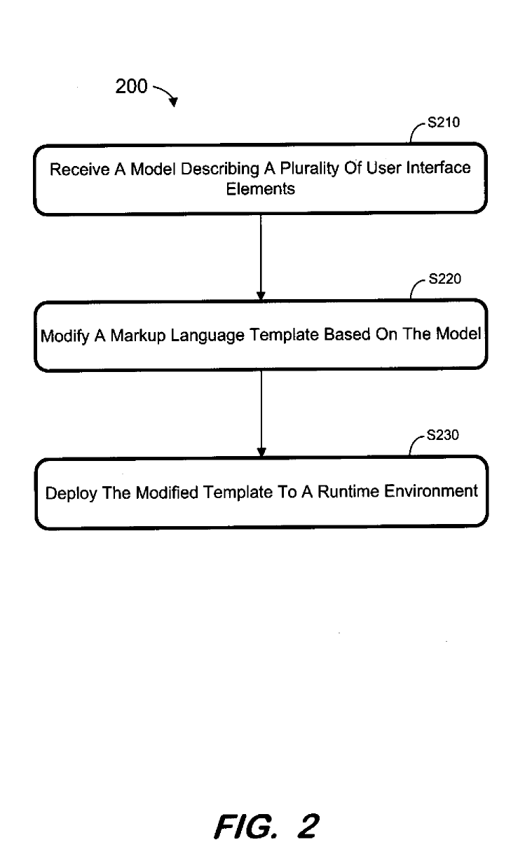

FIG. 2 is a flow diagram of process 200 according to some embodiments. In some embodiments, local deployer 115 executes program code to perform process 200. Process 200 and all other processes mentioned herein may therefore be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a model is received at S210. The model describes a plurality of user interface elements. The model may conform to any suitable language and/or protocol. According to some embodiments, the model conforms to XGL.

Next, at S220, a markup language template is modified based on the model. The markup language template may comprise the output of a dummy application that is formatted according to a desired runtime engine. According to some examples, a dummy XGL model is deployed for execution by a Web Dynpro runtime engine prior to process 200. Such deployment may result in a Web Dynpro template including placeholder fields associated with application or model-specific design-time properties. These properties may include, but are not limited to, the name of the deployable object and XGL content for the UI components. Deployment of several dummy XGL models may occur prior to process 200 in order to provide a selection of markup language templates that may be modified at S220. Moreover, a dummy XGL model may be deployed for execution by any other template-based runtime engine in order to generate a template suitable for modification and subsequent deployment as described below.

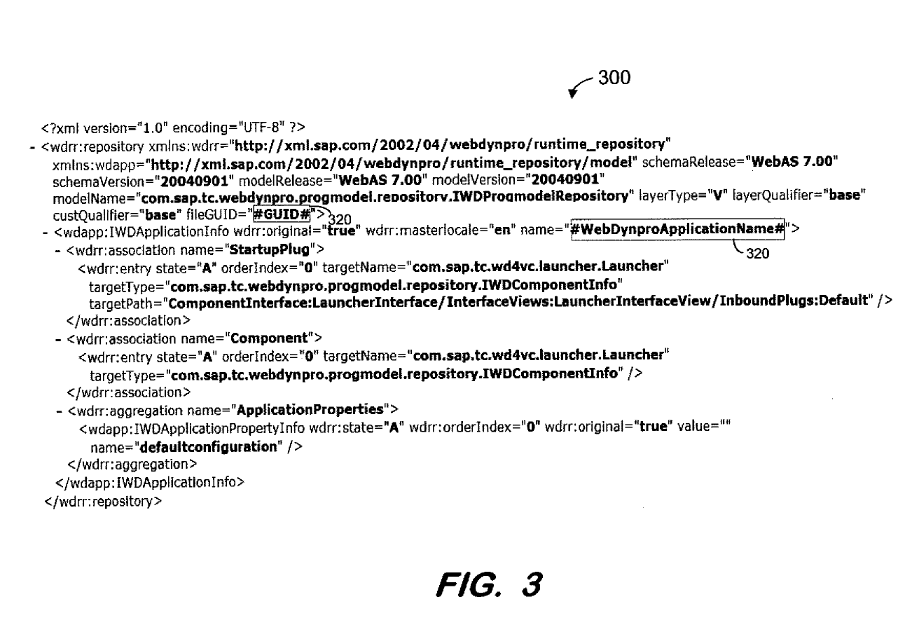

Modification of the markup language template at S220 may comprise replacing the aforementioned placeholder fields with valid information corresponding to the model received at S210. The modification may comprise basic text manipulation as opposed to semantic transformations that would otherwise be applied to the model using conventional systems. FIG. 3 illustrates template 300 according to some embodiments. Template 300 includes placeholder fields 310 and 320 which are populated at S220 as described above.

As mentioned above, local deployer 115 may modify the markup language template based on the received model at S220. According to some embodiments, development server 120 may receive the model at S210 and modify the markup language template based on the received model at S220. For example, deployment module 126 may receive the model from generic generator 113 at S210 and, at S220, may modify a markup language template based thereon. In other examples, generic generator 123 receives a model describing user interface elements (e.g., a GML model) from storyboard 111, generates a model (e.g., an XGL model) based on the received model, and passes the model to deployment module 126 for processing according to process 200.

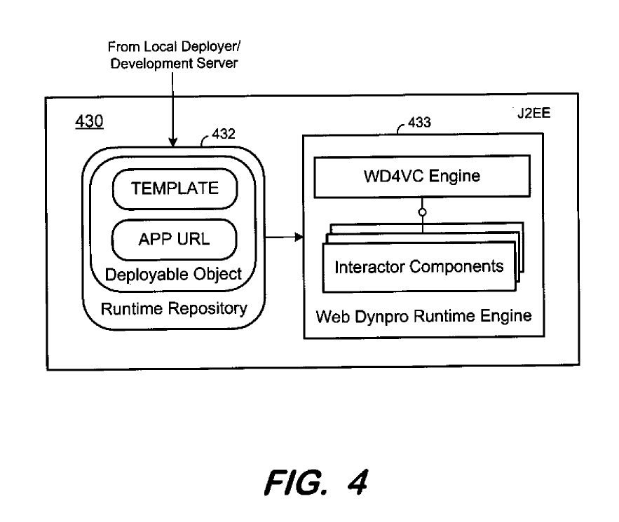

The modified template is deployed to a runtime environment at S230. The runtime environment may comprise an environment capable of executing the modified template. FIG. 4 is a block diagram of runtime environment 430 to which the modified template may be deployed in some embodiments.

Environment 430 comprises a Java 2 Enterprise Edition (J2EE) environment. Environment 430 includes runtime repository 432 and Web Dynpro runtime engine 433. Runtime repository 432 includes a deployable object including a modified markup language template and a Uniform Resource Locator of the application with which the template is associated. Runtime engine 433 includes a Web Dynpro for Visual Composer Engine as well as interactor components to facilitate execution of the deployable object.

As shown, runtime repository 432 may receive a template-based object from local deployer 115 or from development server 120. In this regard, embodiments may allow generation of deployable objects using the conventional techniques described herein and/or the method of process 200. Embodiments are not limited to deployment of a Web Dynpro-formatted XML document to a Web Dynpro runtime engine. The markup language template modified at S220 may conform to any runtime environment that is or becomes known.

Some embodiments may provide efficient runtime access to the deployed information while also maintaining a translation-based infrastructure for the efficient development of platform-independent application GUIs.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
receiving a model describing a plurality of user interface elements;
modifying a markup language template based on the model; and
deploying the modified template to a runtime environment.

2. A method according to claim 1, further comprising:
receiving a second model describing a second plurality of user interface elements;
transforming the second model to a metadata model in accordance with a common metadata framework;
transforming the metadata model to a generic runtime model; and
transforming the generic runtime model to a runtime model associated with a runtime environment.

3. A method according to claim 1, wherein modification of the markup language template based on the model comprises:
replacing placeholder fields of the markup language template with data associated with each of the plurality of components.

4. A method according to claim 1, wherein the model comprises an eXecutable graphical user interface language (XGL) model.

5. A method according to claim 1, wherein the template conforms to the Web Dynpro specification.

6. A medium storing processor-executable program code, the program code comprising:
code to receive a model describing a plurality of user interface elements;
code to modify a markup language template based on the model; and
code to deploy the modified template to a runtime environment.

7. A medium according to claim 6, the program code further comprising:
code to receive a second model describing a second plurality of user interface elements;
code to transform the second model to a metadata model in accordance with a common metadata framework;
code to transform the metadata model to a generic runtime model; and
code to transform the generic runtime model to a runtime model associated with a runtime environment.

8. A medium according to claim 6, wherein the code to modify the markup language template based on the model comprises:
code to replace placeholder fields of the markup language template with data associated with each of the plurality of components.

9. A medium according to claim 6, wherein the model comprises an executable graphical user interface language (XGL) model.

10. A medium according to claim 6, wherein the template conforms to the Web Dynpro specification.

11. An apparatus comprising:
a deployment module to:
receive a model describing a plurality of user interface elements;
modify a markup language template based on the model; and
deploy the modified template to a runtime environment.

12. An apparatus according to claim 11, the deployment module further to:
receive a second model describing a second plurality of user interface elements;
transform the second model to a metadata model in accordance with a common metadata framework;
transform the metadata model to a generic runtime model; and
transform the generic runtime model to a runtime model associated with a runtime environment.

13. An apparatus according to claim 11, wherein modification of the markup language template based on the model comprises:
replacing placeholder fields of the markup language template with data associated with each of the plurality of components.

14. An apparatus according to claim 11, wherein the model comprises an eXecutable graphical user interface language (XGL) model.

15. An apparatus according to claim 11, wherein the template conforms to the Web Dynpro specification.
